(19) United States
(12) Patent Application Publication
(10) Pub. No.: US 2021/0379496 A1
(43) Pub. Date: Dec. 9, 2021

(54) SYSTEM AND METHOD FOR MANIPULATING AUGMENTED REALITY GOLF SIMULATION AND TRAINING USING INTERACTIVE TOOLS

(71) Applicant: LA New Product Development Team LLC, Shreveport, LA (US)

(72) Inventors: Konstantin Dolgan, Shreveport, LA (US); Matthew Williams, Shreveport, LA (US)

(21) Appl. No.: 16/891,068

(22) Filed: Jun. 3, 2020

(51) Int. Cl. A63F 13/812; A63F 13/63; A63F 13/235; A63F 13/573; A63F 13/65; A63F 13/5375; A63F 13/5255; G06F 3/01; G06T 19/20; G06T 19/00

(52) U.S. Cl. CPC A63F 13/812; H04N 13/344; A63F 13/235; A63F 13/573; A63F 13/65; A63F 13/5375; A63F 13/5255; G06F 3/014; G06T 19/20; G06T 19/006; A63F 2300/1031; A63F 2300/305; A63F 2300/6018; A63F 2300/646; A63F 2300/69; A63F 2300/8011; A63F 13/63

(57) ABSTRACT

A system and method for controlling and manipulating augmented reality golf simulation and training is provided. The system includes an augmented reality display device having a left eye near-eye (NED) display element and a right eye near-eye display (NED) element for a user to see 3D rendered virtual game environment, and interactive tools configured with a plurality of sensors for receiving commands from the user, accordingly controlling and manipulating the 3D rendered environment.

### FIELD OF THE INVENTION

The present invention relates to a system and method for 3D rendered reality golf simulation and training. More specifically, the present invention relates to an augmented reality (AR) system and interactive tools incorporating multiple sensors for establishing a control interface in real-time within the 3D rendered environment for improving practicality and efficacy for purposes of golf practice, instruction or entertainment.

### BACKGROUND OF THE INVENTION

Golf is one of the most widely enjoyed sports throughout the world. Also, there are various virtual golf games that are played on the computers. However, golf enthusiasts cannot find any system that provided analytical data to aid in putting and playing golf. This leads to introduction of digital simulation technologies in golf training in order to provide degree of realism, and therefore, entertain the user.

Digital simulation technologies in golf training are disclosed in prior arts. In beginning, golf simulation technology is limited to projection screens, computer monitors and hand-held displays. These options are limited in their degree of realism, and therefore, in their ability to be entertaining or useful to the user. One such example is disclosed in Patent No. WO2011065804A2, a virtual golf simulation apparatus and method capable of allowing golfers to change a view of a green during simulation of a virtual golf course, thereby satisfying various demands of the golfers enjoying virtual golf in a virtual golf simulation environment and inducing interest of the golfers. The virtual golf simulation apparatus includes a setting means for setting the position of a hole cup on a putting green and an image processing unit for generating a hole cup at a predetermined position on the putting green.

With advancement in technologies, improvements are introduced in golf simulation system. Such as introduction of augmented reality glass in golf simulation and training system, capable of blending the real world with a virtual overlay, and therefore can be much more entertaining and/or instructive to a user. One such example is disclosed in U.S. Pat. No. 10,204,456B2, a golf simulation and training system can use with a user's existing standard golf equipment and includes a golf ball launch monitor to track the initial ball positional data, spin and acceleration, and simulate the complete ball path and location or use complete ball tracking data and displays the actual ball path and location. Further, it allows the display of ball tracking data over the real world view and/or an immersive display of a simulated world view, depending on the user's head or view position. Golf simulation graphical views can include various options, including simulated or panoramic photographic views of a golf course, simulated graphics and data superimposed over a real world driving range view, or simple ball tracking data superimposed over a real world view at any location.

However, above disclosed methods employ a separate system for manipulating the golf simulation in augmented reality. Hence, are limited in their degree of realism, and therefore, in their ability to train/instruct the user. Further, there is need for a system to controlling and manipulating augmented reality golf simulation and training more efficiently.

### SUMMARY OF THE INVENTION

An object of the present invention is to provide an augmented reality (AR) system and a method for interaction and controlling different command in 3D rendered virtual game environment.

Another object of the present invention is to provide an augmented reality (AR) system and a method intended for use in virtual and augmented reality technologies to train athletes and players to improve coordination and/or skill.

Another object of the present invention is to provide a 3D rendered reality golf simulation and training system that provides practicality and efficacy for purposes of golf practice, instruction or entertainment.

In carrying out the above objects of the present invention, in one embodiment of present invention, a system and method for 3D rendered reality golf simulation and training includes augmented reality (AR) display capability, which refers to a eyewear or head- or face-mounted wearable visualization technique in which a near-eye display (NED) device uses a display element that is at least partially transparent to overlay (superimpose) computer-generated (virtual) images on at least a portion of the user's field of view of the real world, the overlaid (“virtual”) images may be opaque, such that they completely obscure at least a portion of the user's view of the real world, while in other instances, the overlaid images may be partially transparent. In some instances, the overlaid images may cover the user's entire field of view and/or may completely obscure the user's view of the real world.

In another embodiment of present invention, the system uses augmented reality (AR) display device as the primary visual feedback to the user. The user can use regulation golf clubs, golf balls and practice mats with the system. The augmented reality (AR) display device allow a user to see simultaneously the golf ball and visual overlay of the 3D rendered golf course in relation to the user's visual orientation. Additionally, the augmented reality (AR) display device provide a visual overlay of the track data over the real-world view from user action incorporating golf club and ball. The system supports virtual data display of the ball motion and tracking data, as well as game play elements, as the user hits the ball in a real world environment, such as on a golf course or at a driving range. As the user changes their visual orientation, the virtual course is updated to show the virtual environment in the proper orientation or the virtual data and game play elements are displayed in proper orientation over the real world view.

In another embodiment of present invention, the system enables a user to hit the golf ball in real limited area overlaid with 3D rendered environment, and provides assistance in obtaining visual feedback of what the golf ball trajectory would be on a real golf course. The visual feedback is displayed to the user though the augmented reality (AR) display device.

In another embodiment of present invention, the system uses augmented reality (AR) display device comprises of a storage unit for storing all 3D rendered data necessary for augmented golf simulation including data on a virtual golf courses, user profile, etc. It also comprises of a data processing unit which is configured to collect real-time green terrain information, real-time wind direction and speed information using an internet unit. Further, the data processing unit is configured to process the above information and estimates suggestions for choice of club, hitting line, hitting strength, etc

In another embodiment of present invention, a system and method for 3D rendered reality golf simulation and training includes a wireless hand held interactive tool incorporating a microcontroller with multiple sensors such as, but not limited to optical, magnetic, accelerometers, RFID sensors, BLE transmitters, etc. for establishing a control interface within the 3D rendered environment. The wireless hand held interactive tool is coded with set of commands which upon functioning enables a user to open an interface displayed within the augmented reality (AR) display device visual feedback in real-time thus give advantage to user to manipulate the 3D rendered game environment without switching to any other control interface.

In another embodiment of present invention, a system and method for 3D rendered reality golf simulation and training includes plurality of interactive glove incorporating multiple sensors such as, but not limited to optical, magnetic, accelerometers, RFID sensors, electromagnet coil, piezoelectric sensor, BLE transmitters, etc. for establishing a control interface within the 3D rendered environment. The interactive glove is coded with set of commands which upon functioning enables a user to open an interface displayed within the augmented reality (AR) display device visual feedback in real-time thus give advantage to user to manipulate the 3D rendered game environment without switching to any other control interface. Further, the interactive gloves use conductive fabric to aid in manipulation of the program user interface and enable the range of the motion of each finger serve as commands in the user interface.

In another embodiment of present invention, the interactive tools enables a user to operate various aspects in real-time, in the 3D rendered game environment, such as but not limited to like (a) changing the golf course; (b) changing the golf clubs and golf ball; (c) zoom in/zoom out of a specific section of 3D environment during the game play; (d) Tracing a straight line in the users field of view for practicing on the putting green or for aiding in lining up the users shot on the golf course; (e) gathering weather/wind data from the internet to give advice to player about local wind speed/direction; (f) calculating shot metrics; (g) tracking of score chart; (h) highlight feature on balls to make them more visible when searching where on lands if off the green; (i) to check estimate distance between the hole and location of the player's ball; (j) to track the amount of time played; etc.

In another embodiment of the present invention, a system and method for 3D rendered reality golf simulation and training includes an external central processing unit that communicates the augmented reality (AR) display device and plurality of interactive tool through a wireless communication interface such as, but not limited to wifi, Bluetooth, etc. The external central processing unit comprises of a storage unit for storing all 3D rendered data necessary for augmented golf simulation including data on a virtual golf courses, user profile, etc. It also comprises of a data processing unit which is configured to collect real-time green terrain information, real-time wind direction and speed information using an internet unit. Also, the external processing unit comprises of a visual recognition unit that analyze a real-world object or environment to collect data on its shape and its appearance, and use that data to construct digital 3D models. Further, the data processing unit is configured to process the above information and estimates suggestions for choice of club, hitting line, hitting strength, etc.

In another embodiment of the present invention, a method comprises of providing an augmented reality display device for a user to see a 3D rendered virtual game environment and an interface is configured for displaying visual feedback in real-time, and providing interactive tools configured with a plurality of sensors for receiving commands by the user to control and manipulate the 3D rendered environment. The interactive tool receive a command from the user for opening the interface within the 3D rendered environment and enabling interaction between the interactive tool and the 3D rendered environment for simulation and training in real-time.

### BRIEF DESCRIPTION OF THE DRAWING

The object of the invention may be understood in more details and more particularly description of the invention briefly summarized above by reference to certain embodiments thereof which are illustrated in the appended drawings, which drawings form a part of this specification. It is to be noted, however, that the appended drawings illustrate preferred embodiments of the invention and are therefore not to be considered limiting of its scope, for the invention may admit to other equally effective equivalent embodiments.

FIG. 1 shows an example of augmented reality (AR) display device according to the embodiments of the present invention;

FIG. 2 is a block diagram showing an example of the components of augmented reality (AR) display device according to the embodiments of the present invention;

FIG. 3 shows an example of wireless handheld interactive tool according to the embodiments of the present invention;

FIG. 4 is a block diagram showing an example of the components of wireless handheld interactive tool according to the embodiments of the present invention;

FIG. 5 and FIG. 6 show an example of interactive gloves according to the embodiments of the present invention;

FIG. 7 is a block diagram showing an example of the components of interactive gloves according to the embodiments of the present invention;

FIG. 8 is a block diagram illustrating an external central processing unit of the 3D rendered reality golf simulation and training apparatus according to the embodiments of the present invention;

FIG. 9 is a view illustrating an example of a manipulation menu of the 3D rendered reality golf environment using wireless handheld interactive tool according to the embodiments of the present invention;

FIGS. 10a and 10b are views illustrating an example of drawing practicing line function within the 3D rendered reality golf environment using wireless handheld interactive tool according to the embodiments of the present invention;

FIG. 11 is a view illustrating an example of a manipulation menu of the 3D rendered reality golf environment using interactive gloves according to the embodiments of the present invention;

FIGS. 12a and 12b are views illustrating an example of zoom in/out manipulation within the 3D rendered reality golf environment using interactive gloves according to the embodiments of the present invention;

FIGS. 13a and 13b are views illustrating an example of searching a ball function within the 3D rendered reality golf environment using interactive gloves according to the embodiments of the present invention;

FIGS. 14a and 14b are views illustrating an example of drawing practicing line function within the 3D rendered reality golf environment using interactive gloves according to the embodiments of the present invention; and

FIG. 15 is a block diagram showing a method for manipulating 3D rendered reality golf simulation and training environment using the interactive glove according to the embodiments of the present invention.

### DETAIL DESCRIPTION OF THE DRAWING

The present invention will now be described more fully hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art.

In embodiments of the present invention disclose a system and method for interaction and control by a user in 3D rendered virtual game environment. In some embodiments, the present invention further disclose 3D rendered reality golf simulation and training for purposes of golf practice, instruction or entertainment.

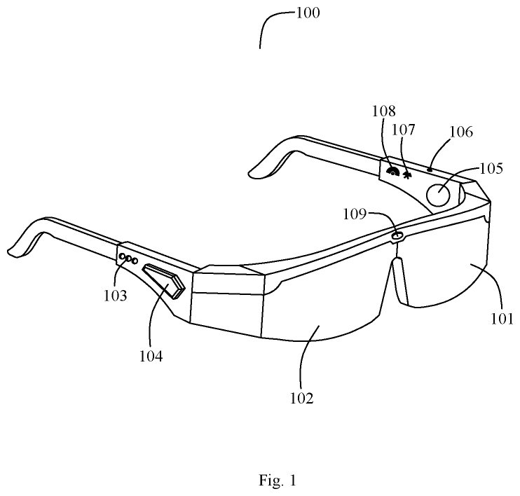

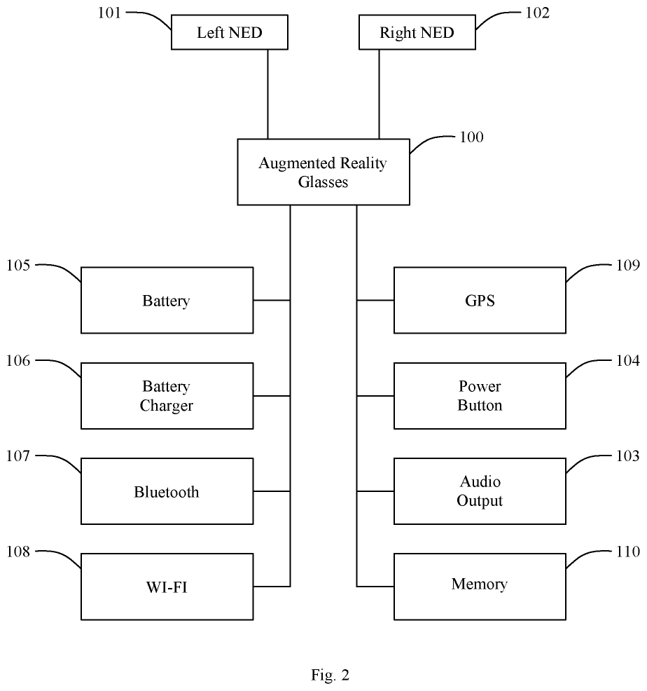

As shown in FIG. 1 is an example of augmented reality (AR) display device 100 and the functional components of the augmented reality (AR) glass are shown in the block diagram of FIG. 2. The augmented reality (AR) display device 100 includes a left eye near-eye (NED) display element 101 and a right eye near-eye display (NED) element 102 that are either fully or semitransparent, or fully opaque and act as the primary visual feedback to the user. In one embodiment, the augmented reality (AR) display device allows a user to see simultaneously the virtual golf club, golf ball and a visual overlay of the 3D rendered golf course in relation to the user's visual orientation.

In one embodiment, the augmented reality (AR) display device 100 also includes an audio output 103 component, which may be a speaker to provide audio feedback to the user, or sound effects to provide audio cues or sound effects to further enhance the user experience. In one embodiment, the augmented reality (AR) display device 100 further include a power ON/OFF button 104 that allow the user to start and stop the functions of the glass.

Further, the augmented reality (AR) display device 100 may includes a battery 105 and battery charging port 106. The battery 105 may be one of several current battery technologies including rechargeable lithium ion or nickel-cadmium batteries or replaceable alkaline batteries. The battery charging port 106 can connect to an external charging voltage source using a wired connection or a wireless charging pad.

The augmented reality (AR) display device 100 also includes one or more wireless communication interface 107, 108 to communicates with external central processing unit. In one embodiment, the augmented reality (AR) display device further includes a Global Positioning System (GPS) sensor 109 for satellite detection of position of the augmented reality (AR) display device 100 relative to the earth. As the user changes their visual orientation, the virtual course is updated to show the virtual environment in the proper orientation or the virtual data and game play elements are displayed in proper orientation over the real world view.

In some embodiments, the augmented reality (AR) display device 100 may include on-chip memory 110 that stores instructions and/or data for carrying out at least some of the operations of the augmented reality (AR) display device 100. Memory 110 may be or includes one or more physical memory devices, each of which can be a type of random access memory (RAM), such as dynamic RAM (DRAM) or static RAM (SRAM), read-only memory (ROM), which may be programmable, such as flash memory, or any combination thereof.

Further, the augmented reality (AR) display device 100 is configured with eye tracking unit. Whereas the augmented reality (AR) display device 100 displays an image to a user of a scene viewable by the user, and receives information indicative of an eye motion of the user by the eye tracking unit for determining an area of interest within the image based on the eye motion.

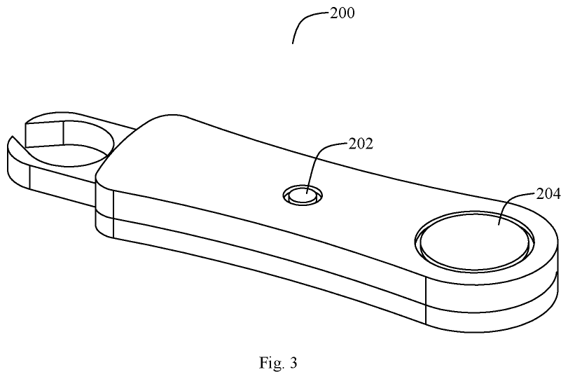

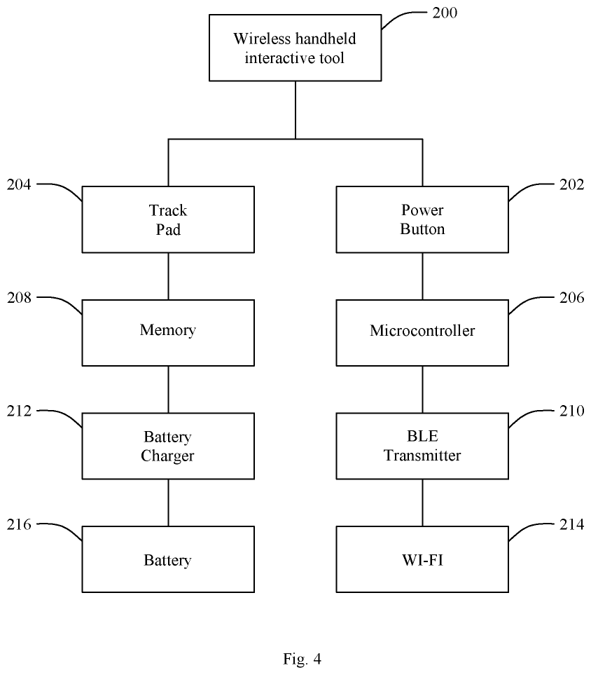

In another embodiment of the present invention FIG. 3 shows an example of wireless handheld interactive tool 200 and the functional components of the wireless handheld interactive tool 200 are shown in the block diagram of FIG. 4. In one embodiment, a wireless hand held interactive tool 200 incorporating a microcontroller 206 with multiple sensors such as, but not limited to optical, magnetic, accelerometers, RFID sensors, BLE transmitters, etc. for establishing a control interface within the 3D rendered environment.

In one embodiment, the wireless hand held interactive tool 200 further include a power ON/OFF button 104 that allow the user to start and stop the functions of the tool. Further, the wireless hand held interactive tool 200 may includes a battery 216 and battery charging port 212. The battery 216 may be one of several current battery technologies including rechargeable lithium ion or nickel-cadmium batteries or replaceable alkaline batteries. The battery charging port 212 can connect to an external charging voltage source using a wired connection or a wireless charging pad.

The wireless hand held interactive tool 200 also includes one or more wireless communication interface 210, 214 to communicates with external central processing unit. In one embodiment, wireless hand held interactive tool 200 further includes a track pad 204 which is used for shuffling and selecting various functions pop-up during its user interface.

In some embodiments, the wireless hand held interactive tool 200 may include on-chip memory 208 that stores instructions and/or data for carrying out at least some of the operations of the user. Memory 208 may be or includes one or more physical memory devices, each of which can be a type of random access memory (RAM), such as dynamic RAM (DRAM) or static RAM (SRAM), read-only memory (ROM), which may be programmable, such as flash memory, or any combination thereof. Further, The wireless hand held interactive tool 200 is coded with set of commands which upon functioning enables a user to open an interface displayed within the augmented reality (AR) glass visual feedback in real-time thus give advantage to user to manipulate the 3D rendered game environment without switching to any other control device.

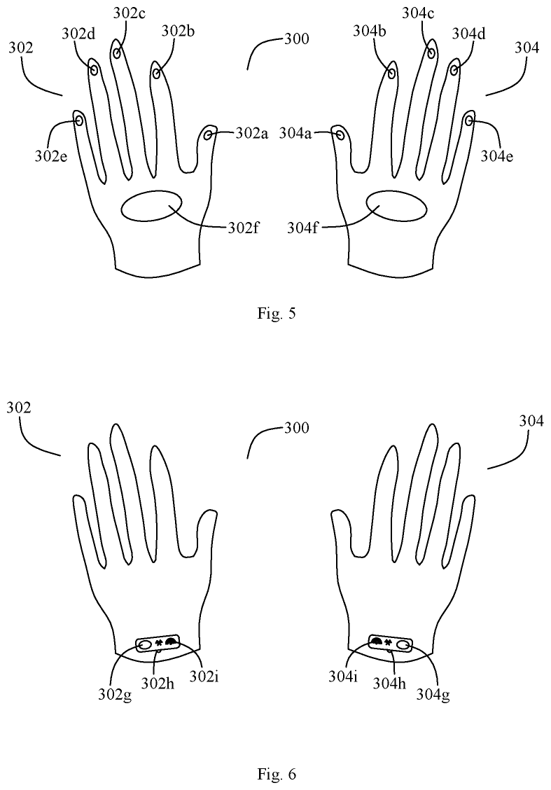

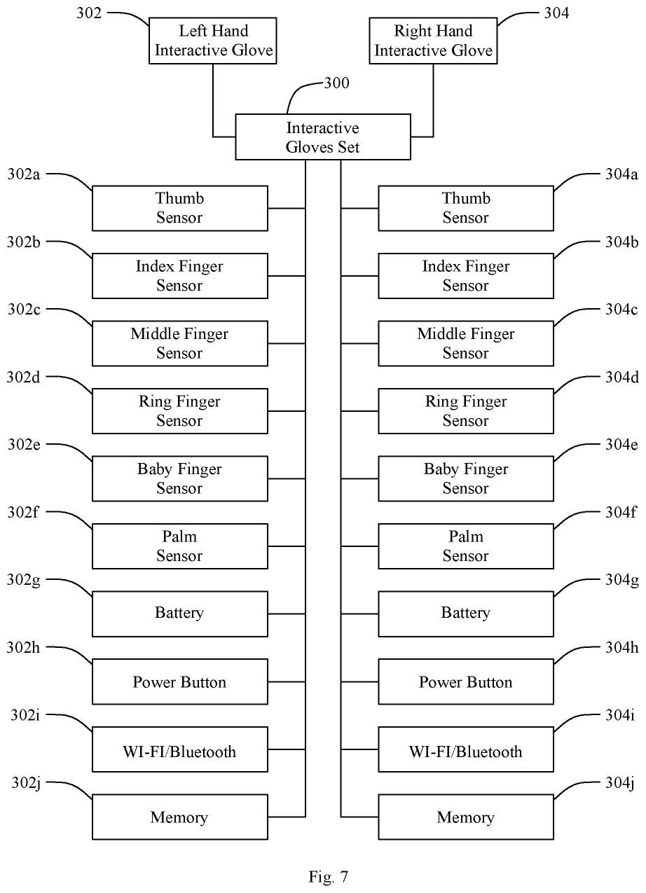

In another embodiment of the present invention FIG. 5 and FIG. 6 illustrate detailed schematic diagrams of interactive glove set 300, a left-hand interactive glove 302 and a right-hand interactive glove 304 and the functional components of which are shown in the block diagram of FIG. 7, in accordance with one of the disclosed embodiments. FIG. 5 illustrates inner side of the left-hand interactive glove 302 and the right-hand interactive glove 304. Plurality of sensors 203a-302f are provided on the inner side of left-hand interactive glove 302 and plurality of sensors 304a-304f are provided on the inner side of left-hand interactive glove 304. Sensors 302a-302f and 304a-304f, incorporated are present for providing texture, vibration and pressure, and for receiving commands by user to manipulate the 3D rendered environment. In one implementation each of the interactive gloves 302, 304 can include one or more electromechanical devices such as, but not limited to an electromagnetic armature that extends or retracts and/or a piezo-electric device that can vibrate. Interactive gloves are made up of conductive fiber and also include extending and contracting elements that can cause the user's fingers to extend or curl, respectively.

FIG. 6 illustrates outer side of the left-hand interactive glove 302 and the right-hand interactive glove 304. The left-hand interactive glove 302 and the right-hand interactive glove 304 may include a battery 302g, 304h along with power buttons 302h, 304h a battery charging port. The batteries 302g, 302h may be one of several current battery technologies including rechargeable lithium ion or nickel-cadmium batteries or replaceable alkaline batteries. The battery charging port can connect to an external charging voltage source using a wired connection or a wireless charging pad. The interactive gloves 302, 304 in the illustrated embodiment also include one or more wireless communication interface 302h such as, but not limited WI-FI, Bluetooth, etc. to communicates with external central processing unit.

In some embodiments, the left-hand interactive glove 302 include sensor 302a-302f such as but limited to Thumb Sensor 302a, Index Finger sensor 302b, Middle Finger sensor 302c, Ring Finger Sensor 302d, Baby Finger Sensor 302e and Palm Sensor 302e.

Similarly, the right-hand interactive glove 304 include sensor 304a-304f such as but limited to Thumb Sensor 304a, Index Finger sensor 304b, Middle Finger sensor 304c, Ring Finger Sensor 304d, Baby Finger Sensor 304e and Palm Sensor 304e.

In some embodiments, interactive gloves 302, 304 may include on-chip memory 302j, 304j that stores instructions and/or data for carrying out at least some of the operations of the interactive gloves 302, 304. Memory 302j, 304j may be or include one or more physical memory devices, each of which can be a type of random access memory (RAM), such as dynamic RAM (DRAM) or static RAM (SRAM), read-only memory (ROM), which may be programmable, such as flash memory, or any combination thereof.

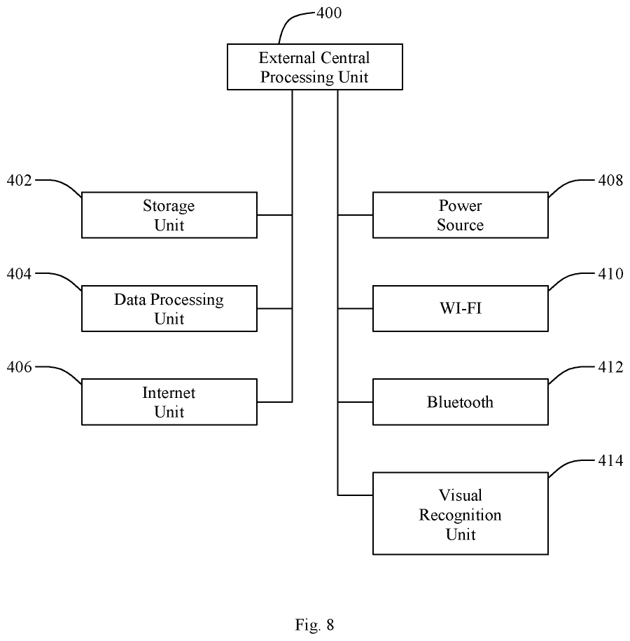

Referring to FIG. 8, a block diagram illustrating an external central processing unit 400 of the 3D rendered reality golf simulation and training apparatus. In one embodiment of the present invention, the external central processing unit 400 that communicates the augmented reality (AR) display device 100 and plurality of interactive tools 200, 302, 304 through a wireless communication interface such as, but not limited to wifi 410, Bluetooth 412, etc. The external central processing unit 400 comprises of a storage unit 402 for storing all 3D rendered data necessary for virtual golf simulation including data on a virtual golf courses, user profile, etc. It also comprises of a data processing unit 404 which is configured to collect real-time green terrain information, real-time wind direction and speed information using an Internet unit 406. Also, the external central processing unit 400 comprises of a visual recognition unit 414 that analyze a real-world object or environment to collect data on its shape and its appearance, and use that data to construct digital 3D models. Further, the data processing unit 404 is configured to process the above information and estimates suggestions for choice of club, hitting line, hitting strength, etc. A power source 408 is provided to power up the external central processing unit 400 for 3D rendered reality golf simulation and training.

In another embodiment of present invention, interactive tools 200, 302, 304 incorporating multiple sensors are used for establishing a control interface within the 3D rendered environment. The interactive tools will be shown as a pointer or wireframe structure within the 3D rendered environment.

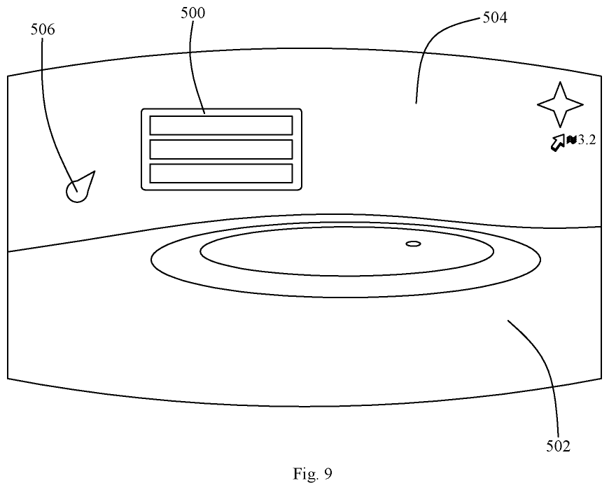

The wireless handheld interactive tool 200 are coded with set of commands which upon functioning enables a user to open an interface 500 displayed within the augmented reality (AR) glass visual feedback 504 in real-time thus give advantage to user to manipulate the 3D rendered game environment 502 without switching to any other control device as shown in FIG. 9. The wireless handheld interactive tool 200 will produce a pointer 506 within the augmented reality (AR) glass visual feedback 504 thus distinguish itself from the 3D rendered game environment 502. The interactive gloves enables a user to operate various aspects in real-time, in the 3D rendered game environment 502, such as but not limited to like (a) changing the golf course; (b) changing the golf clubs and golf ball; (c) zoom in/zoom out of a specific section of 3D environment during the game play; (d) Tracing a straight line in the users field of view for practicing on the putting green or for aiding in lining up the users shot on the golf course; (e) gathering weather/wind data from the internet to give advice to player about local wind speed/direction; (f) calculating shot metrics; (g) tracking of score chart; (h) highlight feature on balls to make them more visible when searching where on lands if off the green; (i) to check estimate distance between the hole and location of the player's ball; (j) to track the amount of time played; etc.

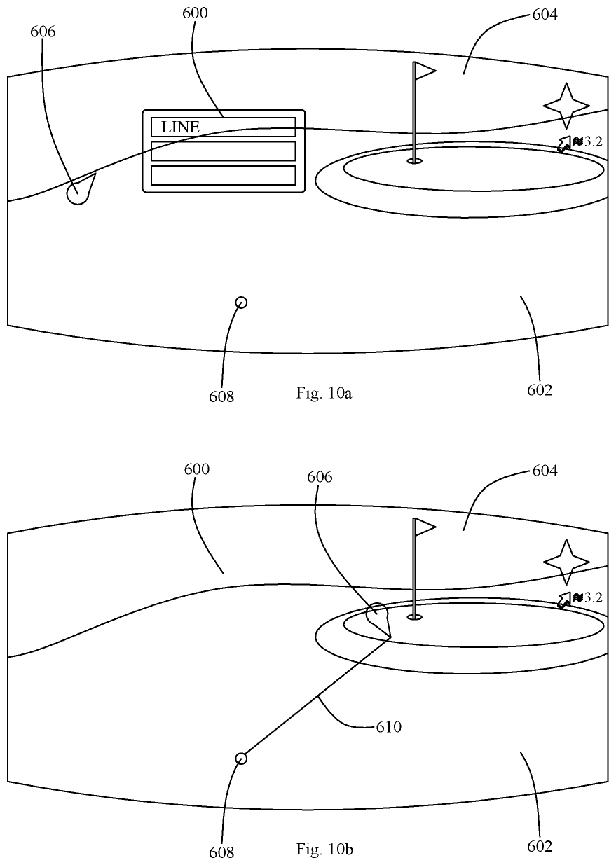

FIGS. 10a and 10b are views illustrating an example of drawing practicing line 600 function within the 3D rendered reality golf environment 602 using wireless handheld interactive tool 606 according to the embodiment of the present invention. After receiving command from user on drawing practicing line function 600, a line 610 can be marked from the ball 608 to the put using interactive gloves 606 on the augmented reality (AR) glass visual feedback 604 in real-time thus allow user to hit the ball efficiently in 3D rendered reality golf environment 602.

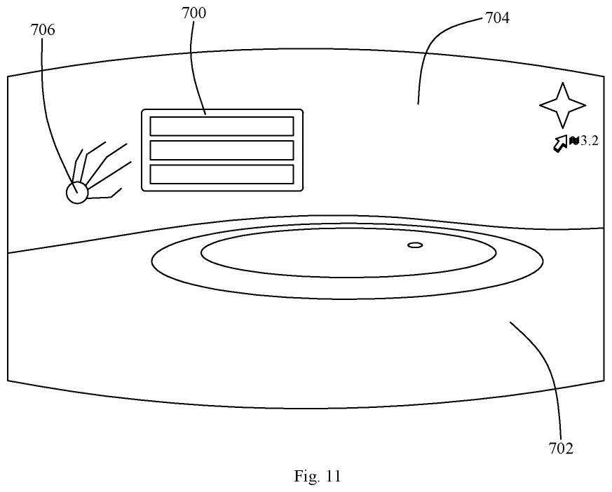

The interactive gloves 302, 304 are coded with set of commands which upon functioning enables a user to open an interface 700 displayed within the augmented reality (AR) glass visual feedback 704 in real-time thus give advantage to user to manipulate the 3D rendered game environment 702 without switching to any other control device as shown in FIG. 11. The interactive glove will produce a wireframe structure 706 within the augmented reality (AR) glass visual feedback 704 thus distinguish itself from the 3D rendered game environment 702. The interactive gloves enables a user to operate various aspects in real-time, in the 3D rendered game environment 702, such as but not limited to like (a) changing the golf course; (b) changing the golf clubs and golf ball; (c) zoom in/zoom out of a specific section of 3D environment during the game play; (d) Tracing a straight line in the users field of view for practicing on the putting green or for aiding in lining up the users shot on the golf course; (e) gathering weather/wind data from the internet to give advice to player about local wind speed/direction; (f) calculating shot metrics; (g) tracking of score chart; (h) highlight feature on balls to make them more visible when searching where on lands if off the green; (i) to check estimate distance between the hole and location of the player's ball; (j) to track the amount of time played; etc.

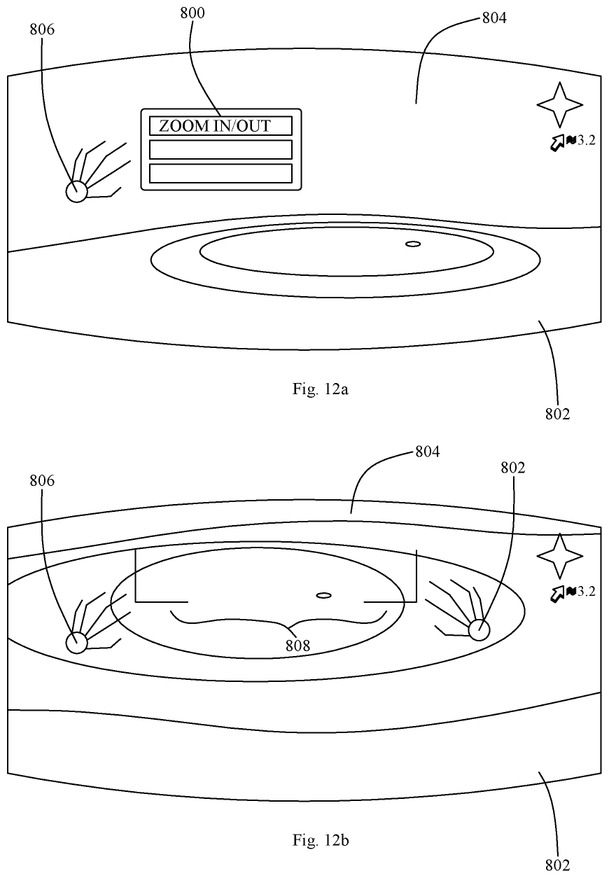

FIGS. 12a and 12b are views illustrating an example of zoom in/out manipulation 800 within the 3D rendered reality golf environment 802 using interactive gloves 806 according to the embodiment of the present invention. After receiving command from user on zoom in/out manipulation 800, both interactive gloves get active and a frame 808 pop-up on the augmented reality (AR) display device visual feedback 804 in real-time thus allow user to see the details of a particular section of green field in 3D rendered reality golf environment 802.

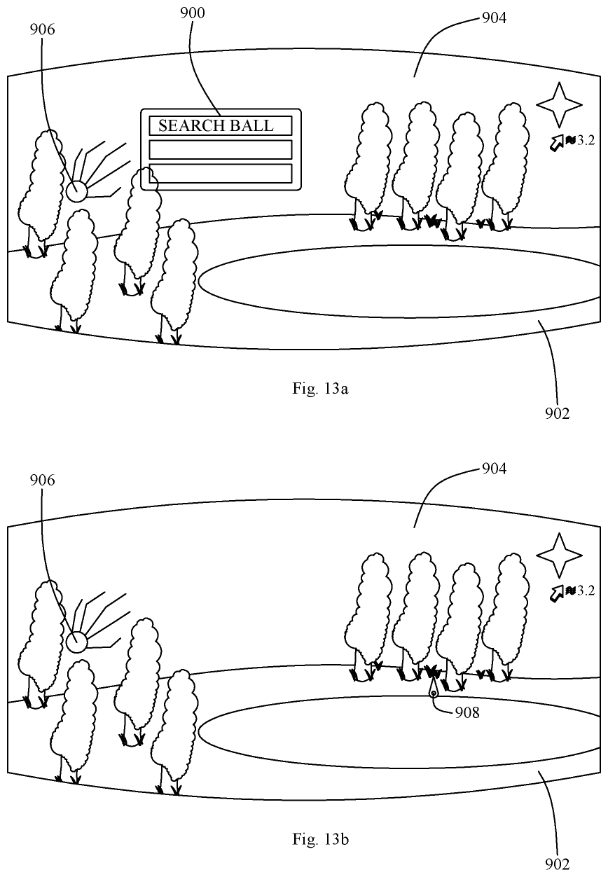

FIGS. 13a and 13b are views illustrating an example of searching a ball function 900 within the 3D rendered reality golf environment 902 using interactive gloves 906 according to the embodiment of the present invention. After receiving command from user on search ball function 900, a marker 908 pop-up on the augmented reality (AR) display device visual feedback 904 in real-time thus allow user to find the golf ball quickly in 3D rendered reality golf environment 902.

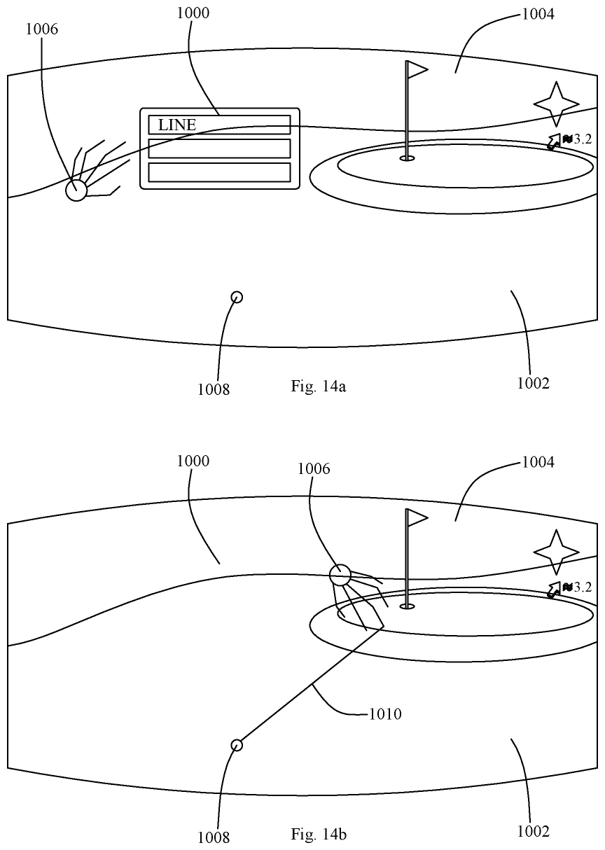

FIGS. 14a and 14b are views illustrating an example of drawing practicing line 1000 function within the 3D rendered reality golf environment 1002 using interactive gloves 1006 according to the embodiment of the present invention. After receiving command from user on drawing practicing line function 1000, a line 1010 can be marked from the ball 1008 to the put using interactive gloves 1006 on the augmented reality (AR) display device visual feedback 10004 in real-time thus allow user to hit the ball efficiently in 3D rendered reality golf environment 1002.

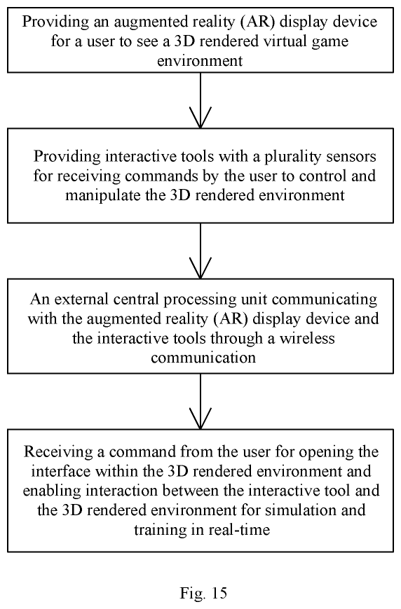

FIG. 15 is a block diagram showing a method for manipulating 3D rendered reality golf simulation and training environment using the interactive glove according to the embodiment of the present invention. The method comprises of; providing an augmented reality glass for a user to see a 3D rendered virtual game environment and an interface is configured for displaying visual feedback in real-time, providing interactive tools configured with a plurality sensors for receiving commands by the user to control and manipulate the 3D rendered environment. The interactive tools receive a command from the user for opening the interface within the 3D rendered environment and enabling interaction between the interactive glove and the 3D rendered environment for simulation and training in real-time.

1. A system for controlling and manipulating in augmented reality golf simulation and training, comprising:
an augmented reality display device includes a left eye near-eye (NED) display element and a right eye near-eye display (NED) element for a user to see a 3D rendered virtual game environment;
an interactive tool configured with a plurality of sensors for providing texture, vibration and pressure, and for receiving commands by the user to control and manipulate the 3D rendered environment; and
a central processing unit communicating with the augmented reality (AR) display device and the interactive tool through a wireless communication;
wherein, the interactive tool is a wireless handheld tools and/or interactive gloves, which is programmed with a set of commands enable opening an interface displayed within the augmented reality (AR) display device in real-time to control and manipulate the 3D rendered game environment.

2. The system of claim 1, wherein the augmented reality (AR) display device further includes one or more wireless communication interface to communicates with the central processing unit.

3. The system of claim 1, wherein the augmented reality (AR) display device further includes an audio output component such as but not limited to a speaker to provide audio feedback to the user, or sound effects to provide audio cues to enhance the user experience.

4. The system of claim 1, the augmented reality (AR) display device is further configured with an eye tracking unit that displays an image to a user of a scene viewable by the user, and receives information indicative of an eye motion of the user for determining an area of interest within the image based on the eye motion;

5. The system of claim 1, wherein the augmented reality (AR) display device further include a power ON/OFF button allowing the user to start and stop functions of the glass.

6. The system of claim 1, wherein the augmented reality (AR) display device further includes a battery for providing power.

7. The system of claim 1, wherein the augmented reality (AR) display device further includes a Global Positioning System (GPS) sensor for satellite detection of position of the augmented reality (AR) display device relative to the earth.

8. The system of claim 1, wherein the augmented reality (AR) display device is further configured to change visual orientation, and accordingly a virtual course is updated to show a virtual environment in proper orientation or a virtual data and game play elements are displayed in the proper orientation over a real world view.

9. The system of claim 1, wherein the interactive gloves include a left-hand interactive glove and a right-hand interactive glove.

10. The system of claim 1, wherein the interactive gloves include the plurality of sensors include such as but limited to Thumb Sensor, Index Finger sensor, Middle Finger sensor, Ring Finger Sensor, Baby Finger Sensor and Palm Sensor.

11. The system of claim 1, wherein the interactive gloves use conductive fabric, further include extending and contracting elements that can cause the user's fingers to extend or curl to aid in manipulation and enable a range of the motion of each finger that serves as commands in the user interface.

12. The system of claim 1, wherein the central processing unit is configured with a storage unit for storing all 3D rendered data necessary for virtual golf simulation including but not limited to data on a virtual golf courses, virtual golf clubs, virtual golf ball, user profile.

13. The system of claim 1, wherein the central processing unit is configured with a visual recognition unit that analyze a real-world object or environment to collect data of shapes and appearances, and uses that data to construct digital 3D models.

14. The system of claim 1, wherein the central processing unit further includes a data processing unit configured to collect real-time green terrain information, real-time wind direction and speed information using an internet.

15. The system of claim 1, wherein the data processing unit is configured to provide suggestions such as but not limited to a choice of club, hitting line and hitting strength.

16. The system of claim 1, wherein the interactive tool enables the user to operate in real-time in the 3D rendered game environment such as but not limited to like changing the golf course, changing the golf clubs and golf ball, zoom in/zoom out of a specific section of 3D environment during the game play, Tracing a straight line in the users field of view for practicing on the putting green or for aiding in lining up the users shot on the golf course, gathering weather/wind data from the internet to give advice to player about local wind speed/direction; calculating shot metrics, tracking of score chart; highlight feature on balls to make them more visible when searching where on lands if off the green, to check estimate distance between the hole and location of the player's ball and to track the amount of time played.

17. A method for controlling and manipulating in augmented reality golf simulation and training, comprising:
providing an augmented reality glass for a user to see a 3D rendered virtual game environment and an interface is configured for displaying visual feedback in real-time;
providing an interactive tool configured with a plurality of sensors for receiving commands by the user to control and manipulate the 3D rendered environment; and
a central processing unit communicating with the augmented reality (AR) glass and the interactive tool through a wireless communication,
wherein, the interactive tool receives a command from the user for opening the interface within the 3D rendered environment and enabling interaction between the interactive tool and the 3D rendered environment for simulation and training in real-time.

18. The method of claim 17, wherein the augmented reality glass further includes one or more wireless communication interface to communicates with the central processing unit.

19. The method of claim 17, wherein the augmented reality (AR) glass is further configured to change visual orientation and accordingly a virtual course is updated to show a virtual environment in the proper orientation or a virtual data and game play elements are displayed in proper orientation over a real world view.

20. The method of claim 17, wherein the central processing unit is configured with a storage unit for storing all 3D rendered data necessary for virtual golf simulation including but not limited to data on a virtual golf courses, user profile.

21. The method of claim 17, wherein a data processing unit is configured to provide suggestions such as but not limited to choice of club, hitting line and hitting strength.

22. The method of claim 17, wherein the interactive tool is a wireless handheld tools and/or interactive gloves.

23. The method of claim 17, wherein the interactive tool enables the user to operate in real-time in the 3D rendered game environment such as but not limited to like changing the golf course, changing the golf clubs and golf ball, zoom in/zoom out of a specific section of 3D environment during the game play, Tracing a straight line in the users field of view for practicing on the putting green or for aiding in lining up the users shot on the golf course, gathering weather/wind data from the internet to give advice to player about local wind speed/direction, calculating shot metrics, tracking of score chart, highlight feature on balls to make them more visible when searching where on lands if off the green, to check estimate distance between the hole and location of the player's ball and to track the amount of time played.
